(19) United States
(12) Patent Application Publication
(10) Pub. No.: US 2008/0284836 A1
(43) Pub. Date: Nov. 20, 2008

(54) Method of Ink-Jet Printing

(76) Inventors: Julie Baker, Hertfordshire (GB); John M. Higgins, Middlesex (GB)

Correspondence Address: EASTMAN KODAK COMPANY;PATENT LEGAL STAFF, 343 STATE STREET, ROCHESTER, NY, 14650-2201, US

(21) Appl. No.: 10/597,578

(22) PCT Filed: Jan. 17, 2005
(86) PCT No.: PCT/GB05/00160

§ 371 Date: Jul. 31, 2006

(30) Foreign Application Priority Data
Feb. 5, 2004 (GB) 0402573.0

(51) Int. Cl. B41J 3/407

(52) U.S. Cl. 347/106

(57) ABSTRACT

The surface properties, such as surface roughness and gloss, of a printed image on an ink-jet receiver comprising a voided polymer ink-receiving layer, especially a foamed polymer ink-receiving layer, can be improved (i.e. reduce surface roughness and increase gloss) by applying heat and/or pressure to the ink-jet receiver after printing of an image such as by the passage of the printed image through a fuser. Method of printing; ink-jet print, and use of a fusing device.

### FIELD OF THE INVENTION

The present invention relates to the field of ink-jet printing. More specifically, it relates to a method of printing onto an ink-jet receiver comprising a voided polymer layer, especially a foamed polymer layer, in order to improve the surface properties of a print formed thereon and to such ink-jet prints.

### BACKGROUND OF THE INVENTION

Commercially available photo quality ink-jet receivers can generally be classified into one of two categories according to whether the principal component material forms an ink-receiving layer that is porous or non-porous in nature. Porous ink-jet receivers are typically formed from inorganic materials with a polymeric binder. When ink is applied to the receiver, it is quickly absorbed into the porous layer by capillary action. However, the open nature of the porous layer can contribute to instability of printed images, particularly when exposed to environmental gases such as ozone. Ink-jet receivers having a non-porous layer are typically formed by the coating of one or more polymeric layers onto a support. When ink is applied to such receivers, the polymeric layers swell and absorb the applied ink. Due to limitations of the swelling mechanism, this type of media is slow to absorb the ink. Once dry, however, printed images tend to be relatively stable when subjected to light and ozone.

Hybrid ink-jet receivers which provide the benefits of both the porous and non-porous receivers described above are being investigated as alternatives to porous and non-porous receivers. One example is that described in our European Patent Application No. 03015858.8, which comprises a foamed polymer layer prepared by activating blowing agents in a hydrophilic polymer layer coated onto an ink-jet support. The resulting foamed hydrophilic polymer layer provides the benefit of rapid uptake of ink usually associated with a porous receiver and the benefit of relative stability to light and ozone more normally associated with a non-porous receiver.

U.S. Pat. No. 6,497,480 describes a method of ink-jet printing which allows rapid uptake of ink into an ink-receiving layer whilst protecting the resulting print from environmental instability. In this method, the ink is applied to a receiver having a porous ink-receiving layer and a porous ink-transporting layer consisting of fusible polymeric particles and a hydrophobic binder. Subsequent to printing, the porous ink-transporting layer is fused to provide a continuous polymeric layer on the surface of the print providing improved abrasion resistance, water resistance and print density.

### PROBLEM TO BE SOLVED BY THE INVENTION

Whilst ink-jet receivers having voided polymer receiving layers, such as foamed polymer receiving layers, display benefits of both porous and non-porous receivers, some foamed polymer receiving layers, for example when prepared by activating blowing agents in a hydrophilic polymer layer, can have greater surface roughness and poor gloss by comparison with currently commercially available ink-jet receivers. It would be desirable to provide a method of printing having the benefits of porous and non-porous receivers and having acceptable levels of surface roughness and gloss.

### SUMMARY OF THE INVENTION

According to a first aspect of the present invention, there is provided a method of printing comprising the steps of loading an ink-j et printer with an ink-jet receiver comprising a voided polymer ink-receiving layer; printing an image onto the ink-jet receiver using said printer to generate a print; and applying pressure and/or heat to the print thereby improving the surface properties.

In a second aspect of the invention, there is provided an ink-jet print obtainable by the above method.

### ADVANTAGEOUS EFFECT OF THE INVENTION

The present invention provides a method of printing which enables the use of a voided polymer receiver thereby generating a print having the benefits of both porous and non-porous receivers whilst having an acceptable level of surface roughness and gloss.

### BRIEF DESCRIPTION OF THE DRAWINGS

FIG. 1 shows a cross-section of an ink-jet receiver comprising a foamed hydrophilic polymer layer on a support.

FIG. 2 show a cross-section of an ink-jet receiver of FIG. 1 following passage of the ink-jet receiver through a fuser device.

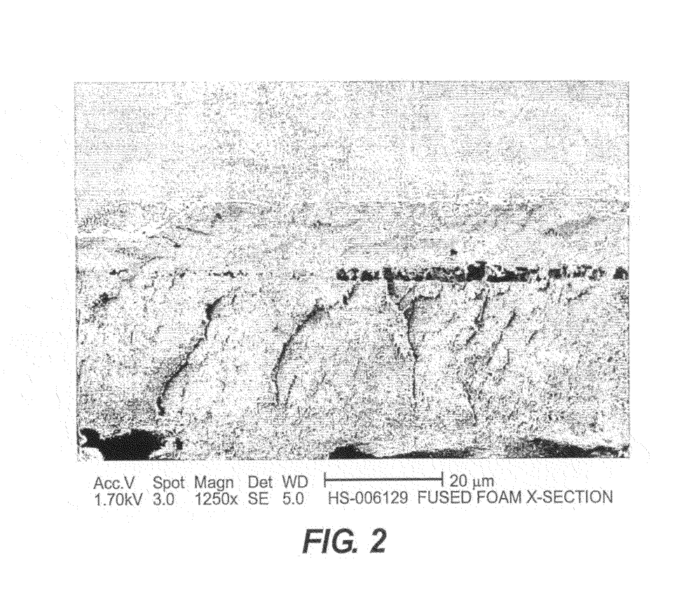

### DETAILED DESCRIPTION OF THE INVENTION

As set out above, the method of printing according to the present invention comprises applying pressure and/or heat to a print generated using an ink-jet printer on an ink-jet receiver comprising a voided polymer ink-receiving layer. Surface properties of the print that may be improved by the method include surface roughness (i.e. generating a print with a smoother surface) and glossiness.

Preferably, the method comprises applying heat and pressure to the print. The heat and pressure may be applied to the print, for example by the use of a fusing device. In a preferred embodiment, the ink-jet print is treated by the application of heat and/or pressure using a belt fuser or a nip roller. In any case, it is preferable that the means for applying heat and/or pressure to the print, e.g. a fusing device, is integral to or associated with the ink-jet printer.

The ink-jet receiver that may be used according to this invention may be any such receiver having a voided polymer layer, whereby ink may be rapidly absorbed into the porous voided structure and, preferably, the polymer is capable of absorbing the ink on printing.

By voided polymer layer, it is meant a polymer layer consisting substantially of a polymer material having voids or void spaces formed therein, in an open and/or closed cell arrangement, thereby increasing the ink uptake significantly by comparison with a corresponding unvoided polymer layer. Preferably, the voided polymer layer is a foamed polymer layer.

Preferably, the ink-receiving layer comprises a foamed hydrophilic polymer, such as, for example, polyvinyl alcohol (PVA), polyethylene oxide (PEO), polyvinylpyrrolidone (PVP) and gelatin.

The ink-jet receiver may comprise one or more layers, for example, two or three layers, of foamed polymer material, which layers may be the same or different. Preferably, where more than one layer of foamed polymer material is present, the layers of foamed polymer material are adjacent one another and polymer is of the same type in each.

The polymer may be present in any suitable amount for the particular utility, which may depend on the amount and type of ink and on the absorbant properties of the particular properties used. A laydown of polymer onto a support may be, for example, from 2-40 g/m², preferably 4-40 g/m², more preferably 6-20 g/m² and still more preferably 8-18 g/m², which may be coated as a single layer or in two or more layers. Such amounts would be useful, for example, if PVA was the polymer material.

The foamed polymer layer of the ink-jet receiver may comprise foam made by any effective method of making polymer foams, such as by mechanical whipping of gases into a polymer solution to trap gas bubbles in a matrix before hardening of the foam, by volatilisation of low boiling-point liquids (e.g. methylene chloride) in a mixture with a suitable polymer by heating (externally or from heat of polymerisation), or by introducing chemical blowing agents into a polymer solution, which blowing agents generate gas by thermal degradation. Alternatively, for example, a polymer foam may be generated by gas dissolved in a polymer expanding as the pressure of the system is reduced, or by incorporating microspheres into a polymer mass, which microspheres consist of gas-filled polymer that expands upon heating.

The foam may be formed either before or after coating of the polymer material onto a suitable support. Suitable such supports include resin-coated paper, film base, acetate, polyethylene terephthalate (PET), a printing plate support or any other suitable support.

In a preferred embodiment of the invention, the foamed polymer layer is obtainable by coating a support with a solution comprising a hydrophilic polymer and a blowing agent; and, either prior to or after the step of coating said support, interacting with said solution, to cause said blowing agent to generate gas bubbles within the solution causing foaming of said hydrophilic polymer.

The step of interacting with the solution may be performed after coating of the support and comprises applying heat to said solution. For example, heat may be applied to the solution during drying of the coated support. In this case, the receiver could be prepared by the coating of a support with an aqueous solution of a hydrophilic polymer with a blowing agent followed by the application of heat to the solution, for example by heating the entire structure of the coated support. The coating is dried, and bubbles are caused to form in the coated layer by heating the layer or the entire coated material to a suitable temperature. In a more preferred embodiment, the blowing agent may be selected such that the heat provided to dry the coated support is sufficient to cause decomposition of the blowing agent and generation of the gas. In an alternative example, a compound which on heating releases an acid, is added to the solution. When the solution is then heated, acid is released which reacts with the blowing agent to cause decomposition of the blowing agent and the consequent generation of gas. The blowing agent may be mixed with the polymer in solution before coating or may be added on top of the coated polymer solution. Preferably, in order to flier improve the surface characteristics of the ink-jet receiver, activation of the blowing agent is delayed, or preferably, prevented until after coating of the layer of polymer and blowing agent solution by, for example, dual melting the blowing agent(s) into one of the layers at the hopper, or where two or more components are required for initiation of decomposition of the blowing agents, the prevention of activation of the blowing agents can be achieved by adding one of the components to the polymer solution prior to coating and dual melting the other one or more components at the hopper. This method prevents the components being able to react until they all come together in the hopper. Alternatively, each component required to interact to cause activation of the blowing agents may be added to a separate layer of the coating, thereby preventing the components being able to react until all the layers are coated together.

Alternatively, or in addition, the interaction with the solution may comprise applying heat to the solution prior to coating of the support such that the solution when coated onto the support has bubbles already formed therein. In this case, the receiver is prepared by coating a support with a layer of foamed polymer solution in which bubbles are formed. The bubbles are formed in an aqueous solution of a hydrophilic polymer and blowing agent. The aqueous solution containing the bubbles is then coated onto a support. The foamed polymer solution is created by heating the solution prior to its application to the support, to promote the decomposition of the blowing agent to generate a gas. Alternatively, an acid may be added to the solution to react with the blowing agent again to generate a gas within the solution. Preferably, a compound which on heating releases an acid, is added to the solution. When the solution is heated, acid is released which reacts with the blowing agent to cause decomposition of the blowing agent and the consequent generation of gas.

The foamed polymer layer typically comprises a network of open cells or an arrangement of closed voids in a polymeric matrix.

In either approach described above, any suitable method of coating may be used to coat the solution onto the support. For example, curtain coating, bead coating, air knife coating or any other suitable method may be used. Typically, in bead coating, a set-up is used in which a multi-layer arrangement of liquids is applied to a moving web via a hopper.

Preferably, the pH of the polymer solution is less than pH 6 before addition of the blowing agents, since it has been found that if the pH of the solution is dropped before the blowing agents are added or the blowing agents are dual melted into a layer in which the pH has been reduced the surface roughness of the final coating is significantly reduced. More preferably, the pH is reduced to a value of 5 or below, for example to about pH 2 or about pH 4 or to a pH in the range from 2 to 5. More preferably, the pH is reduced to a value of 4 or below, still more preferably to a pH value in the range 2 to 4.

The blowing agent used in the method of the present invention is selected in dependence on the temperature at which it reacts to generate gas. By selecting a blowing agent that reacts at a relatively low temperature, material may be formed without requiring high temperatures. Examples of suitable blowing agents for use in the method of the present invention, include a mixture of sodium nitrite and ammonium chloride, metal carbonates and bicarbonates. Further examples of suitable blowing agents are described in, for example, the Handbook of Polymeric Foams and Foam Technology, Edited by Daniel Klempner and Kurt C. Frisch, Chapter 17: Blowing Agents for Polymer Foams, Section 3 Chemical Blowing Agents, (Chapter written by Dr. Fyodor A. Shutov).

The amount of blowing agent in the polymer solution for use in generating the foamed polymer layer may, for example, be up to about 200% by weight as a proportion of blowing agent to polymer. Preferably, it would be in an amount of at least 5%, such as in an amount of from about 10% to about 60%, more preferably from about 30% to about 50%. Where more than one layer of a polymer solution for generating a foamed polymer material is coated onto a support, the proportion of blowing agent in each layer may vary, but is typically within the above ranges.

Preferably, a surfactant may be added to the solution of hydrophilic polymer and blowing agent. The surfactant serves as a coating aid during coating of solution onto the support. For example, a fluorosurfactant such as Olin 10 G, Lodyne S100 or Zonyl FSN may be added to the hydrophilic polymer used in the porous hydrophilic polymer layer. The amount of surfactant present in a polymer solution for use in generating a foamed polymer material is preferably in the range of from about 0.01% to about 2.0% by weight as a proportion of polymer present and more preferably about 0.01% to about 1.0%. Where more than one layer of polymer solution is applied to a support, the proportion of surfactant in each layer may vary, but is in each case preferably within the aforementioned ranges.

In a most preferred embodiment, the polymer solution for use in generating the foamed polymer layer of the ink-jet receiver comprises PVA as a hydrophilic polymer with, for example, sodium nitrite and ammonium chloride as blowing agents, which may be dual coated onto the support, and the foamed polymer formed after coating. Typical heat and pressure conditions applied using a belt fuser at a rate of 25 mm/s (0.5 inches per second (IPS)) are a temperature of 150° C. (300° F.) and 1080 kg/m (60 lbs/inch) nip pressure. The treatment conditions may be varied depending on the degree of gloss, surface roughness, etc. desired, and of course on the properties of the particular foamed polymer material.

On a more general application, the conditions for applying heat and/or pressure to the voided polymer receiver, especially a foamed polymer receiver, may range from 40-200° C., preferably in the range 60-160° C. and up to 2100 kg/m (120 lbs/inch) nip pressure, preferably from 720-1800 kg/m (40-100 lbs/inch) nip pressure. The rate that the receiver is passed, for example through a fusing device, may range from 6.25 to 500 mm/s, preferably from 10 to 250 mm/s.

Depending upon the amount of heat and/or pressure applied to the receiver, and on the specific properties of the voided polymer layer utilised in the invention, further benefits in image density, image stability and water fastness may be exhibited.

Ink-jet inks for use according to the present invention may be any suitable inks, many such inks being known in the art, and are typically liquid compositions comprising a solvent or carrier liquid (such as water or aqueous alcohol solution), dyes and/or pigments, humectants, organic solvents, detergents, thickeners, preservatives and the like. The precise qualities of the voided polymer receiver, such as a foamed polymer receiver, chosen may depend on the requirements of the type of printing and the type of ink and vice versa.

In a further aspect, the present invention provides a method of improving the surface properties of a voided polymer layer, especially a foamed polymer layer, said method comprising applying heat and/or pressure to the surface of said layer. According to this aspect, the polymer layer preferably comprises a foamed hydrophilic polymer and may be suitable for use as an ink-receiving layer of an ink-jet receiver. In any case, the possible variations and preferences described above in respect of the other aspects of the invention are applicable also to the method of improving the surface properties of a foamed polymer layer.

The invention is illustrated, without limitations by the following Examples.

### EXAMPLES

An ink-jet receiver comprising a foamed polymer ink-receiving layer on a resin coated paper support was prepared.

Three layers of a solution comprising polyvinyl alcohol (PVA) and surfactant were coated onto a resin coated paper support on a bead coating machine using a standard slide hopper. The layer nearest the support consisted of 5.7 g/m² of PVA and 0.106 g/m² of surfactant. The middle layer consisted of 6.5 g/m² of PVA and 0.212 g/m² of surfactant. The top layer consisted of 5.4 g/m² of PVA and 0.636 g/m² of surfactant. The blowing agents sodium nitrite and ammonium chloride were then dual melted into the top ink-receiving layer The 40% sodium nitrite solution was dual melted using a laydown of 12.4 ml/m² (which is equivalent to 4.96 g/m² of sodium nitrite). The 20% ammonium chloride solution was dual melted using a laydown of 19.2 ml/m² (which is equivalent to 3.84 g/m² of ammonium chloride). The total PVA laydown of the entire coating pack was 17.6 g/m² and the total laydown of blowing agents was 8.8 g/m² (50% by weight as a proportion of the total PVA laydown).

A control coating was prepared at the same time where the layers were identical to those described above, except the blowing agents (sodium nitrite and ammonium chloride) were omitted, i.e. this coating contained just PVA and surfactant.

To initiate the blowing process, the dryers inside the coating track were set to 90° C. through which the coating used to demonstrate this invention and the control were passed.

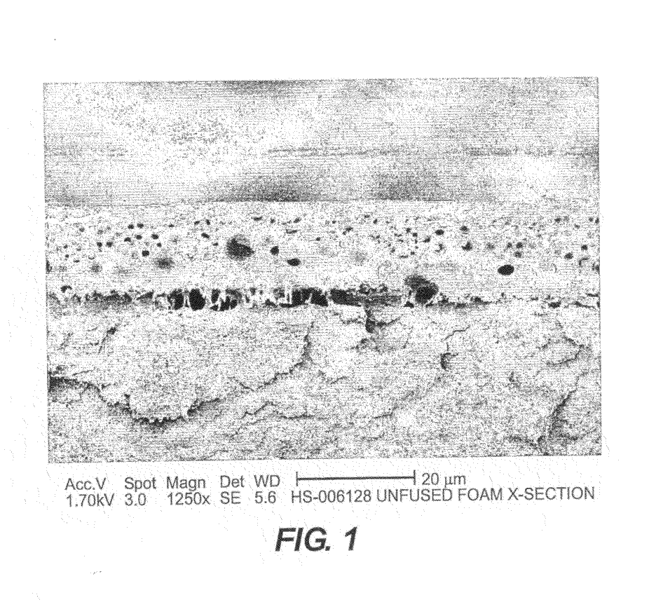

The coated support containing the PVA and the blowing agent resulted in a foamed receiver in which bubbles were formed throughout the three-layer pack. FIG. 1 shows a cross-section of the foamed receiver.

Both the foamed polymer coating and the PVA control were treated by applying heat and pressure by passing them through a belt fuser at 12.5 mm/s (0.5 inches per second (IPS)) at 150° C. (300° F.) and under 1080 kg/m (60 lbs/inch) nip pressure.

Both coatings were then compared to untreated samples for surface roughness and gloss, the results of which are presented in Table 1 and Table 2 respectively.

TABLE 1
The effect on surface roughness of applying heat and pressure treatment

| Receiver | Treated/Untreated | Rz (μm) | Rpm (μm) |
|---|---|---|---|
| Foamed receiver | Untreated | 29.72 | 20.96 |
| | Treated | 17.32 | 5.61 |
| PVA control | Untreated | 2.64 | 1.73 |
| | Treated | 2.76 | 2.23 |

Key.
Rz = Average peak to valley height
Rpm = Average height

The data in Table 1 indicate that treating the foamed receiver by applying heat and pressure using a fusing device results in a large reduction in surface roughness, whereas it had no effect on the PVA control because that was already so smooth.

TABLE 2
The effect on gloss of applying heat and pressure treatment

| | Treated/ | | | |
|---|---|---|---|---|
| Receiver | Untreated | 20° Gloss | 60° Gloss | 85° Gloss |
| Foamed | Untreated | 5.8 | 26.2 | 29.1 |
| receiver | Treated | 19.3 | 52.1 | 62.3 |
| | Delta | 13.5 | 25.9 | 33.2 |
| PVA Control | Untreated | 69.8 | 83.2 | 95.0 |
| | Treated | 80.5 | 87.4 | 98.2 |
| | Delta | 10.7 | 4.2 | 3.2 |

The data in Table 2 indicate that treating the foamed receiver by applying heat and pressure using a fusing device results in a large increase in gloss, whereas only marginally increases in gloss are seen when the PVA control is treated. The foamed polymer ink-jet receiver has gloss of 52.1 at 60°. It is considered that a gloss of greater than 40 at 60° is an acceptable level of gloss for an ink-j et print to be accepted by a consumer as a gloss print.

From this example, it can be seen that treating the foamed receiver by applying heat and pressure using a fusing device results in large improvements in both surface roughness and gloss. These large improvements were not seen when a PVA coated support corresponding to a typical non-porous receiver control was treated.

1. A method of printing comprising the steps of
loading an ink-jet printer with an ink-jet receiver comprising a voided polymer ink-receiving layer;
printing an image onto said ink-jet receiver using said printer to generate a print; and
applying pressure and/or heat to said print thereby improving the surface properties.

2. The method of claim 1, wherein the application of pressure and/or heat to said print reduces the roughness and increases the gloss of the surface of said print.

3. The method of claim 1, wherein said voided polymer ink-receiving layer is a foamed polymer ink-receiving layer.

4. The method of claim 3, wherein said polymer is a hydrophilic polymer.

5. The method of claim 4, wherein said polymer is selected from polyvinyl alcohol (PVA), polyethylene oxide (PEO), polyvinylpyrrolidone (PVP) and gelatin.

6. The method of claim 4, wherein said ink-jet receiver is obtainable by coating a support with a solution comprising said hydrophilic polymer and a blowing agent; and, either prior to or after the step of coating said support, interacting with said solution, to cause said blowing agent to generate gas bubbles within said solution causing foaming of said hydrophilic polymer.

7. The method of claim 6, wherein the step of interacting with said solution is performed after coating of said solution onto said support and comprises applying heat to said solution.

8. The method of claim 6, wherein the proportion by weight of said blowing agent to said polymer is from about 10% to about 60%.

9. The method of claim 1, wherein said application of pressure and/or heat to said print is carried out using a fusing device.

10. An ink-jet print obtainable by the method of claims 1.

11. Use of a fusing device to improve the surface properties and/or image properties of an ink-jet print formed on an ink-jet receiver comprising a foamed polymer ink-receiving layer by applying heat and/or pressure to the surface of said print.
